(19) United States
(12) Patent Application Publication
(10) Pub. No.: US 2013/0083194 A1
(43) Pub. Date: Apr. 4, 2013

(54) VIDEO MONITORING SERVER AND METHOD

(71) Applicants: JEN-HSIUNG CHARNG, Tu-Cheng (TW); CHIEN-MING CHANG, Tu-Cheng (TW); SHIH-HAO LIU, Tu-Cheng (TW); YU-HSIANG TSAO, Tu-Cheng (TW)

(72) Inventors: JEN-HSIUNG CHARNG, Tu-Cheng (TW); CHIEN-MING CHANG, Tu-Cheng (TW); SHIH-HAO LIU, Tu-Cheng (TW); YU-HSIANG TSAO, Tu-Cheng (TW)

(73) Assignee: HON HAI PRECISION INDUSTRY CO., LTD., Tu-Cheng (TW)

(21) Appl. No.: 13/615,596

(22) Filed: Sep. 14, 2012

(30) Foreign Application Priority Data
Sep. 30, 2011 (CN) 201110297987.4

(51) Int. Cl. G06F 15/16; H04N 7/18

(52) U.S. Cl. 348/143

(57) ABSTRACT

A video monitoring server and method are provided. The video monitoring server generates a monitoring list and controls a streaming media server to convert video captured by a camera into streaming media. The video monitoring server downloads the streaming media from the streaming media server and selects a picture from the downloaded streaming media as an icon of a monitoring record corresponding to the camera. The video monitoring server sends the monitoring list to an electronic device, and notifies the streaming media server to send the streaming media to the electronic device when a user clicks the icon of the monitoring record corresponding to the camera.

### BACKGROUND

1. Technical Field

Embodiments of the present disclosure relate to monitoring technology, and particularly to a video monitoring server and method.

2. Description of Related Art

A video monitoring system is a hardware-based and software-based system used for the purpose of observing an area (e.g., a bank). The video monitoring system will include a monitoring center. The monitoring center includes a plurality of screens, such as a liquid crystal display (LCD) screen to display video captured by a camera. However, a user must be physically present in the monitoring center to watch the video captured by the camera, which is tedious and time-consuming. Thus, there is room for improvement in the art.

### BRIEF DESCRIPTION OF THE DRAWINGS

FIG. 1 is a schematic diagram of one embodiment of a video monitoring system.

FIG. 2 is a block diagram of one embodiment of a video monitoring server of the video monitoring system in FIG. 1.

FIG. 3 is a flowchart of one embodiment of a video monitoring method.

FIG. 4 illustrates one embodiment of a monitoring list.

### DETAILED DESCRIPTION

All of the processes described below may be embodied in, and fully automated via, function modules executed by one or more general purpose processors of a computer. Some or all of the methods may alternatively be embodied in specialized hardware. The function modules may be stored in any type of computer-readable medium or other computer storage device.

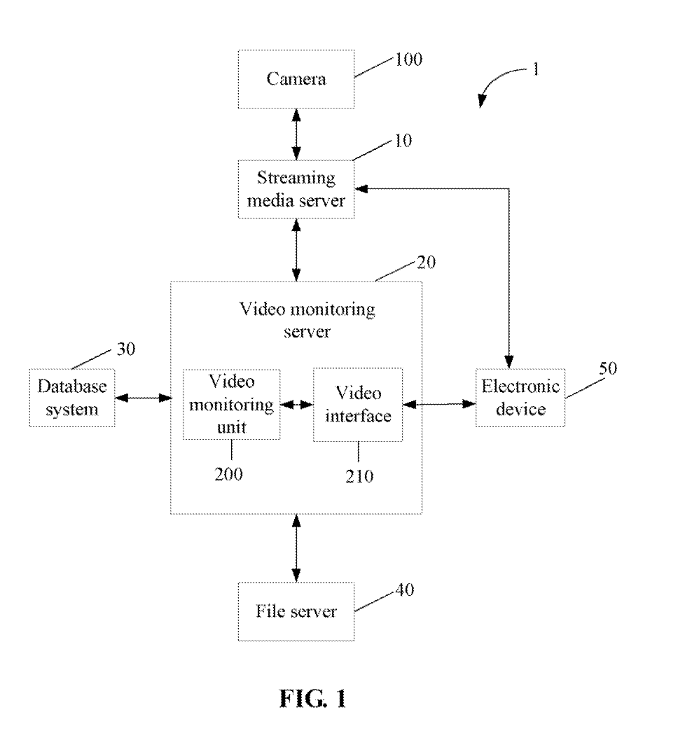

FIG. 1 is a schematic diagram of one embodiment of a video monitoring system 1. The video monitoring system 1 may automatically provides video monitoring in accordance with the streaming media downloaded from a streaming media server 10.

The video monitoring system 1 includes one or more cameras 100, the streaming media server 10, a video monitoring server 20, a database system 30, a file server 40 and an electronic device 50.

In some embodiments, each of the cameras 100 is connected to the streaming media server 10, as shown in FIG. 1. Each of the cameras 100 captures video of a monitored area (such as a bank hall) and sends the captured video to the streaming media server 10. In one embodiment, each of the cameras 100 may be installed at a fixed position (e.g., a main gate) of the monitored area. The monitored area may be, but is not limited to, an area where a bank is located.

The streaming media server 10 receives the captured video from the cameras 100 and converts the captured video into streaming media. The streaming media server 10 is connected to the video monitoring server 20 and sends the streaming media to the video monitoring server 20. In one embodiment, the streaming media server 10 may be a data processing device or a computing device such as a personal computer, an application server, or a workstation, for example.

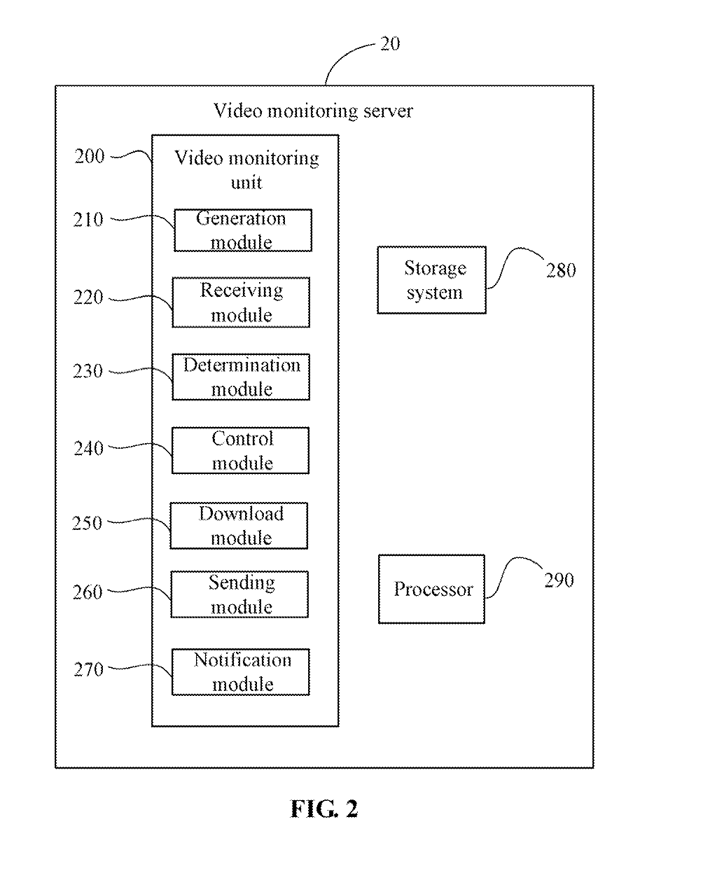

The video monitoring server 20 is connected to the electronic device 50, as shown in FIG. 1. The video monitoring server 20 includes a video monitoring unit 200 and a video interface 210. Further details regarding to the video monitoring unit 200 are described with respect to FIG. 2. The video monitoring server 20 is connected to the electronic device 50 using the video interface 210. The video interface 210 may be, but is not limited to, a simple object access protocol (SOAP) module. The electronic device 50 provides an operation interface for controlling one or more operations of the video monitoring server 20. For example, the user may input an identification and a password in the operation interface and login the video monitoring server 20, then the user uses the electronic device 50 to control the video monitoring server 20. The electronic device 50 is also connected to the streaming media server 10 and receives the streaming media from the streaming media server 10. The electronic device 50 may be a mobile phone, a personal digital assistant (PDA), a handheld game player, a digital camera, a tablet computer, or any other portable electronic device.

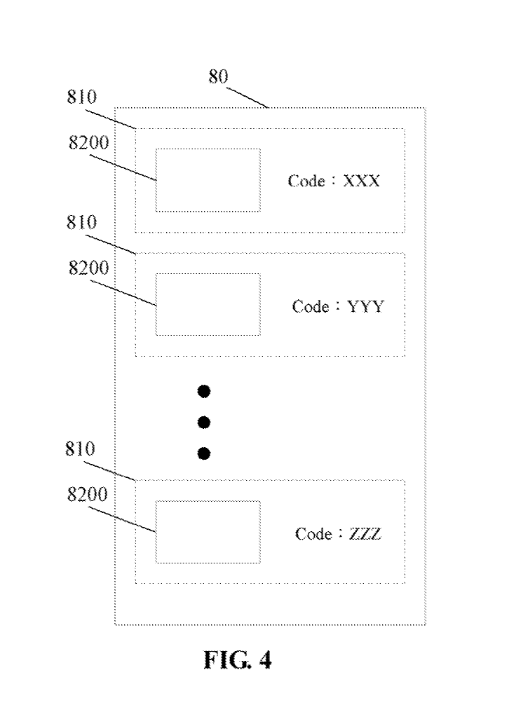

The video monitoring server 20 is also connected to the database system 30 using database connectivity interfaces, such as open database connectivity (ODBC) or java database connectivity (JDBC). In one embodiment, the video monitoring server 20 may be a data processing device or a computing device such as a personal computer, an application server, or a workstation, for example. The database system 30 may store position information of each of the cameras 100, an electronic map, predetermined verification information, and a monitoring list. The position information of each of the cameras 100 includes a position where the camera 100 is installed. The position information of each of the cameras 100 is also associated with the electronic map. The predetermined verification information may include, but is not limited to, the password (e.g., “123456”) and the identification (e.g., “Emliy”). As shown in FIG. 4, the monitoring list 80 includes one or more monitoring records 810. Each of the monitoring records 810 corresponds to a camera 100. Each of the monitoring records 810 includes an icon 8200 and a code (e.g., either “XXX,” or “YYY,” or “ZZZ”) of the camera 100. The electronic device 50 can obtain the streaming media from the streaming media server 10 when a user clicks the icon 8200 on the electronic device 50. For example, when a user clicks the icon 8200 using a finger or clicks the icon 8200 using a mouse device on the electronic device 50, the user can watch the streaming media received from the streaming media server 10. In addition, the icon 8200 is activated when the icon 8200 includes a picture from the streaming media. In other words, if the icon 8200 does not contain the picture from the streaming media, the icon 8200 is not activated.

The video monitoring server 20 is further connected to the file server 40. The file server 40 may backup the streaming media received from the video monitoring server 20. In addition, the file server 40 may be a backup server. For example, if the video monitoring server 20 does not work, the file server 40 will automatically act as the backup server and play a role of the video monitoring server 20.

FIG. 2 is a block diagram of one embodiment of the video monitoring server 20 including a video monitoring unit 200. The video monitoring unit 200 automatically collects the streaming media and processes the streaming media. In one embodiment, the video monitoring unit 200 includes a generation module 210, a receiving module 220, a determination module 230, a control module 240, a download module 250, a sending module 260, and a notification module 270. The modules 210-270 may include computerized code in the form of one or more programs that are stored in the storage system 280. The computerized code includes instructions that are executed by the at least one processor 290 to provide functions for modules 210-270. The storage system 280 may be a memory stick, a hard disk drive, or a cache.

The generation module 210 generates a monitoring list 80 and associates each of a plurality of monitoring records 810 of the monitoring list 80 with a camera 100.

The receiving module 220 receives verification information from the electronic device 50. In one embodiment, the user input the identification and the password into the electronic device 50, and the receiving module 220 receives the identification and the password from the electronic device 50.

The determination module 230 determines if the received verification information is valid. In one embodiment, if the received verification information is the same as the predetermined verification information, the received verification information is valid.

The control module 240 controls the streaming media server 10 to convert the video captured by the camera 100 into streaming media if the received verification information is valid. In one embodiment, the control module 240 sends a command to the streaming media server 10 and starts the streaming media server 10. The streaming media server 10 controls the cameras 100 to capture the video and converts the captured video into the streaming media.

The download module 250 downloads the streaming media from the streaming media server 10 and selects a picture from the downloaded streaming media as an icon 8200 of the monitoring record 810 corresponding to the camera 100. In one embodiment, the icon 8200 is activated upon the condition the icon 8200 includes a selected picture.

The sending module 260 sends the monitoring list 80 to the electronic device 50.

The notification module 270 notifies the streaming media server 10 to send the streaming media to the electronic device 50 when the user clicks the icon 8200 of the monitoring record 810 corresponding to the camera 100. In one embodiment, if the user clicks the icon 8200 of the monitoring record 810 on the electronic device 50, the electronic device 50 sends the command to the video monitoring server 20. The notification module 270 controls the streaming media server 10 to send the streaming media to the electronic device 50 if the video monitoring server 20 receives the command from the electronic device 50.

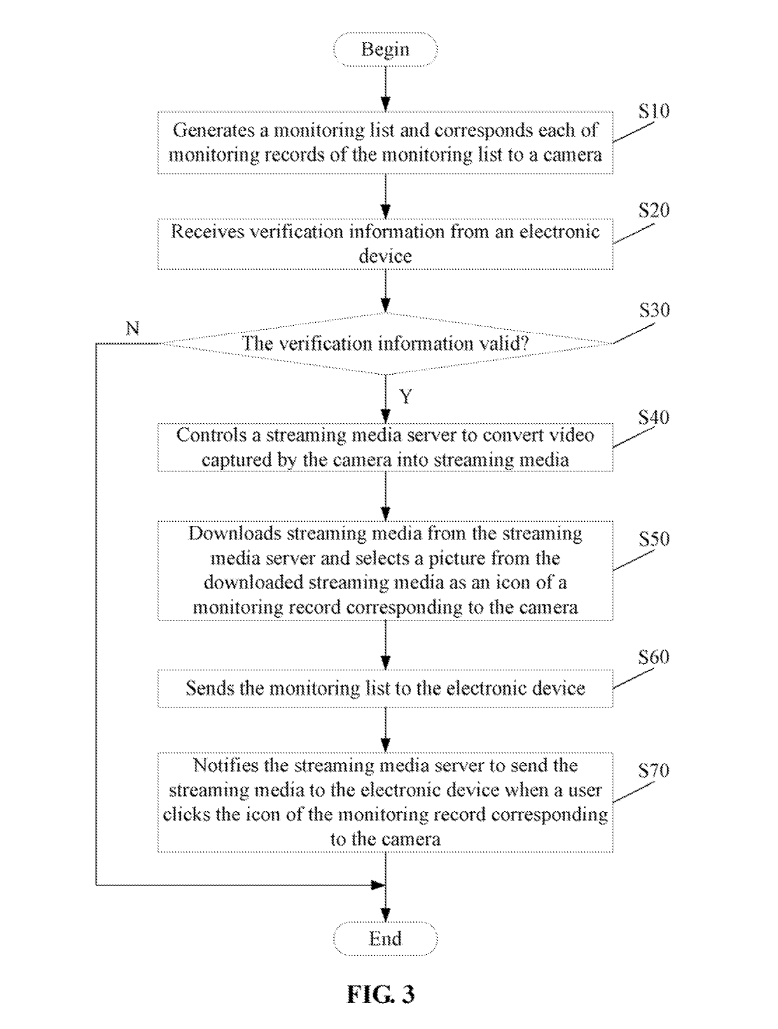

FIG. 3 is a flowchart of one embodiment of a video monitoring method. Depending on the embodiment, additional steps may be added, others deleted, and the ordering of the steps may be changed.

In step S10, the generation module 210 generates a monitoring list 80, and associates each of a plurality of monitoring records 810 of the monitoring list 80 with a camera 100.

In step S20, the receiving module 220 receives verification information from the electronic device 50. In one embodiment, the user input the identification and the password to the electronic device 50, the receiving module 220 receives the identification and the password from the electronic device 50.

In step S30, the determination module 230 determines if the received verification information is valid. In one embodiment, if the password is “123456” and the identification is “Emily,” the received verification information is determined to be valid, the procedure goes to step S40. Otherwise, if the password is “345678” and the identification is “Kobe,” the received verification information is determined to be invalid, the procedure ends.

In step S40, the control module 240 controls the streaming media server 10 to convert the video captured by the camera 100 into streaming media. In one embodiment, the control module 240 sends a command to the streaming media server 10 and starts the streaming media server 10. The streaming media server 10 controls the cameras 100 to capture the video and converts the captured video into the streaming media.

In step S50, the download module 250 downloads streaming media from the streaming media server 10 and selects a picture from the downloaded streaming media as an icon 8200 of a monitoring record 80 corresponding to the camera 100. In one embodiment, the icon 8200 includes a selected picture, and the icon 8200 is activated.

In step S60, the sending module 260 sends the monitoring list 80 to the electronic device 50.

In step S70, the notification module 270 notifies the streaming media server 10 to send the streaming media to the electronic device 10 when the user clicks the icon 8200 of the monitoring record 810 corresponding to the camera 100. In one embodiment, if the user clicks the icon 8200 of the monitoring record 810 on the electronic device 50, the electronic device 50 sends the command to the video monitoring server 20. The notification module 270 controls the streaming media server 10 to send the streaming media to the electronic device 50 if the video monitoring server 20 receives the command from the electronic device 50.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A video monitoring server, comprising:
a storage system;
at least one processor; and
one or more programs stored in the storage system and being executable by the at least one processor, the one or more programs comprising:
a generation module generates a monitoring list, wherein the monitoring list comprises one or more monitoring records and each of the one or more monitoring records corresponds to a camera connected to a streaming media server;
a control module controls the streaming media server to convert video captured by the camera into streaming media;
a download module downloads the streaming media from the streaming media server and selects a picture from the downloaded streaming media as an icon of a monitoring record corresponding to the camera;
a sending module sends the monitoring list to an electronic device, which is connected to the video monitoring server and the streaming media server; and
a notification module notifies the streaming media server to send the streaming media to the electronic device when a user clicks the icon of the monitoring record corresponding to the camera.

2. The server of claim 1, wherein the video monitoring server comprises a video interface, wherein the video interface is a simple object access protocol (SOAP) module.

3. The server of claim 2, wherein the electronic device is connected to the video interface of the video monitoring server.

4. The server of claim 1, wherein the icon is activated when the icon comprises the picture from the streaming media.

5. The server of claim 1, wherein the electronic device is selected from the group consisting of a mobile phone, a personal digital assistant (PDA), a handheld game player, a digital camera and a tablet computer.

6. A computer-based video monitoring method, the method comprising:
generating a monitoring list, wherein the monitoring list comprises one or more monitoring records, and each of the one or more monitoring records corresponds to a camera connected to a streaming media server;
controlling the streaming media server to convert video captured by the camera into streaming media;
downloading the streaming media from the streaming media server and selecting a picture from the downloaded streaming media as an icon of a monitoring record corresponding to the camera;
sending the monitoring list to an electronic device, which is connected to the video monitoring server and the streaming media server; and
notifying the streaming media server to send the streaming media to the electronic device when a user clicks the icon of the monitoring record corresponding to the camera.

7. The method of claim 6, wherein the video monitoring server comprises a video interface, wherein the video interface is a simple object access protocol (SOAP) module.

8. The method of claim 7, wherein the electronic device is connected to the video interface of the video monitoring server.

9. The method of claim 6, wherein the icon is activated when the icon comprises the picture from the streaming media.

10. The method of claim 6, wherein the electronic device is selected from the group consisting of a mobile phone, a personal digital assistant (PDA), a handheld game player, a digital camera and a tablet computer.

11. A non-transitory computer-readable medium having stored thereon instructions that, when executed by a computing device, causing the computing device to perform a video monitoring method, the method comprising:
generating a monitoring list, wherein the monitoring list comprises one or more monitoring records, and each of the one or more monitoring records corresponds to a camera connected to a streaming media server;
controlling the streaming media server to convert video captured by the camera into streaming media;
downloading the streaming media from the streaming media server and selecting a picture from the downloaded streaming media as an icon of a monitoring record corresponding to the camera;
sending the monitoring list to an electronic device, which is connected to the video monitoring server and the streaming media server; and
notifying the streaming media server to send the streaming media to the electronic device when a user clicks the icon of the monitoring record corresponding to the camera.

12. The non-transitory computer-readable medium of claim 11, wherein the video monitoring server comprises a video interface, wherein the video interface is a simple object access protocol (SOAP) module.

13. The non-transitory computer-readable medium of claim 12, wherein the electronic device is connected to the video interface of the video monitoring server.

14. The non-transitory computer-readable medium of claim 11, wherein the icon is activated when the icon comprises the picture from the streaming media.

15. The non-transitory computer-readable medium of claim 11, wherein the electronic device is selected from the group consisting of a mobile phone, a personal digital assistant (PDA), a handheld game player, a digital camera and a tablet computer.
